(19) United States
(12) Patent Application Publication
(10) Pub. No.: US 2012/0115413 A1
(43) Pub. Date: May 10, 2012

(54) Method for Suspending Transmission and Reception of Text Messages and Phone Calls while Drivin

(75) Inventors: Stanislaw Czaja, Cardiff, CA (US); Ilona Stawski, Avon Lake, OH (US); Muhammad Afsar, San Diego, CA (US)

(73) Assignee: IPCOMM LLC, Cardiff, CA (US)

(21) Appl. No.: 13/244,534

(22) Filed: Sep. 25, 2011

Related U.S. Application Data
(60) Provisional application No. 61/412,075, filed on Nov. 10, 2010.

(51) Int. Cl. H04W 48/04

(52) U.S. Cl. 455/26.1

(57) ABSTRACT

The present invention relates to the field of wireless communication and specifically the use of a cell-phone to monitor safe driving by suspending all communication to/from mobile terminal when the user of such terminal is an active driver, unless the vehicle is not a train and it is equipped with the hands-free functionality, or it is not in motion, or the active driver status has changed, or unless the user makes an emergency call.

### RELATED U.S. APPLICATION

The present Application claims the priority under the 35 U.S.C. section 119 of Provisional Application No. 61/412,075 entitled “METHOD AND APPARATUS PROHIBITING TEXT MESSAGES WHILE DRIVING”, filled on Nov. 10, 2010, which is assigned to the assignee hereof and hereby expressly incorporated by reference herein.

### FIELD OF THE INVENTION

The present invention relates to the field of wireless communication and specifically to use of a cell-phone to monitor safe driving habits by suspending transmission and reception of text messages (SMS) and phone calls by the driver of a car not equipped with the hands-free equipment unless such transmission is related to emergency services.

### BACKGROUND

The danger associated with sending or receiving text messages (SMS, MMS), or voice calls while driving is well known and documented and against the law in most states.

Many studies show that while legally intoxicated person traveling at 70 mph applies brakes on average 4 feet beyond the baseline, a sober person receiving text message applies brakes on average 36 feet beyond the baseline, and while sending text message, on average 70 feet beyond the baseline.

Available statistic indicates that several thousands of lives is lost each year in US due to the accidents caused by drivers distracted with sending or receiving text messages, or engaged in phone conversation while driving.

However, regardless of those statistics, 66% of the respondents of 2007 Harris Interactive poll admitted they text while driving. Those numbers are even higher among the youngest drivers who already are in far then their share of road accidents. As such, method for automatic detection that the user of the mobile terminal is in a moving vehicle not equipped with the hands-free device while performing the function of a driver may save many thousands of lives.

### SUMMARY OF THE INVENTION

The proposed invention will suspend transmission or reception of text messages and/or phone calls by the driver of the moving motor vehicle not equipped with the hands-free equipment unless such transmission is related to emergency services.

This functionality is achieved by determining the user is in a moving car (by one of several method describe below and in detailed embodiments), and that he/she is a driver of this car.

The determination of the speed can be achieved either by the mobile terminal or by the cellular network by observing the output of the channel estimation function then determine the shift in the Doppler frequency of the received signal which is proportional to the vehicle speed.

In addition, mobile terminal may obtain the velocity of the vehicle by observing the change in the acceleration vector of the MEMS (Microelectromechanical System) accelerometer. Such MEMS accelerometers are common devices embed in most of today smart-phones to enhance UI (User Interface) experience—such as screen orientation, improve navigation, etc.

The procedure to acquire status of the driver may be as simple request conformation that the user is not a driver—for example when the application detects the mobile terminal velocity is larger then 3 mph; or when car is in motion and the user interacts with the mobile terminal UI in way inconsistent with making emergency calls; or as complicated as using the mobile terminal camera to obtain such information.

Depending on the user profile, each time SMS or non-emergency call is sent/received and the vehicle is in motion, a status of such communication including time and location is recorded. Such status may be sent automatically to the predetermined recipients (for example: parents, insurance provider, etc.), using mobile terminal SMS service or downloaded later upon request.

In addition since shock (due to an impact), is considered as an instantaneous acceleration with a non-periodic characteristics, when recording of such acceleration exceeds a predefined threshold it may be used to determine an accident. At such instance, the speed of the vehicle, location and call status (was the user/driver) in active communication will be recorded. Depending on the user profile, such information may be sent to the predefined recipients, such as: parents, insurance provider, police, or downloaded later upon request.

Such a monitoring system can operate using any of wireless WAN technology such as: cdma2000 (1xRTT and EV-DO), UMTS, LTE, WiMax, etc.

Various embodiments for a method for monitoring the driver safety status are presented.

In one embodiment, the method may rely entirely on the MEMS accelerometer embedded within the mobile terminal to measure vehicle velocity, since velocity—expressed in meters per second (m/s), comprises both the rate of displacement (acceleration)—expressed in meters per second squared (m/s²). An example of such embodiment is presented in FIG. 1.

In such embodiment, the status of the hands-free function is known to the mobile terminal through the process known as association at the time it moves within the range of such equipment. When the vehicle speed is detected, mobile terminal verifies status of the vehicle driver, either by reading previously stored status, if such status flag equals “valid” or, if driver status equals “not-valid” by sending driver status conformation message to the mobile terminal UI.

The driver status becomes “valid” after the mobile terminal detected the velocity above the “drive” threshold and verified—through the terminal UI that the user is not actively driving a car. The driver status becomes “non-valid” when the mobile terminal detects the car stopped and started again (possible change of the driver).

For an outgoing SMS or voice communication (user originated), and if hands-free function is active, or the hands-free is inactive but the user is not an active driver, communication is allowed without any restriction. Otherwise, if the user is an active driver, but the communication is not intended for emergency (for example E911), communication is disallowed and an audio and text messages are sent to the mobile terminal UI informing of restriction.

For an incoming SMS or voice communication (user terminated), and if hands-free function is active, or the hands-free is inactive but the user is not an active driver, communication is allowed without any restriction. Otherwise, if the user is an active driver, but the communication is not intended for emergency (for example: Reverse E911, Emergency Broadcast, etc.), communication is disallowed without any notification to the user (rings, etc. is suspended with “busy” signal indication and the incoming communication is redirected to the user mail-box.

In addition, if an accident is detected (an instantaneous change in acceleration with non-periodic characteristics which exceeds a predefined threshold), speed of the vehicle, it's location and call status (was the user/driver in active communication) is recorded and depending on the user profile, such information is sent to the predefined recipients or stored for later evaluation.

In another embodiments, the velocity of the vehicle can be obtained by the wireless network serving base station (BS), through the observation of Doppler frequency shift in the user mobile terminal uplink communication channel. Since wireless channel in which mobile network operates is inherently prone to many distortions, such as: attenuation, dispersion, multipath, Raileigh fading, Doppler fading, etc. Estimation of such distortion is essential to the operation of the BS and each mobile terminal.

Part of this distortion is due to the signal constellation shift induced by the terminal movement when the transmitted frequency f₀ is received (by a moving terminal) at frequency f₀+f_{d}. This change in frequency f_{d} is known as Doppler shift and it is proportional to the speed of the terminal and expressed as:

f_{d}≈−2f₀/c=−2vᵣ/λ

An example of such embodiment is presented in FIG. 2.

In such embodiment, after determining the speed of the vehicle, the BS scheduler can verify user hands-free and driver status from the previously stored state, and if such status flag equals “valid” or, if driver status equals “not-valid” by sending hands-free and driver status request message(s) to the user mobile terminal. If the returned hands-free status and driver status are negative (hands-free is active or user is not the active driver), the BS may rout the call to the mobile terminal, otherwise, the BS will direct the incoming call to the user mail box.

Similarly, when the BS detects the mobile terminal access probe (user attempts to place a call), while determining the user originating such call is in a moving vehicle, it may verify user hands-free and driver status from the previously stored state, if such status flag equals “valid” or, if driver status equals “not-valid” by sending hands-free and driver status request message(s) to the user mobile terminal. If the returned hands-free status and driver status are negative (hands-free is active or user is not the active driver), the BS may terminate call (route to the destination), otherwise, the BS will reject to set-up the call and may send message to the user mobile terminal UI indicating of restrictions.

In yet another embodiment, the velocity of the vehicle can be obtained by the mobile terminal through the observation of Doppler frequency shift in the transmitting BS downlink communication channel. Such measurement is readily available at the output of mobile terminal channel estimation function. An example of such embodiment is presented in FIG. 3.

In such embodiment, the status of the hands-free function is known to the mobile terminal through the process known as association at the time it moves within the range of such equipment. When the vehicle speed is detected, mobile terminal verifies status of the vehicle driver, either by reading previously stored status, if such status flag equals “valid” or, if driver status equals “not-valid” by sending driver status conformation message to the mobile terminal UI.

For an outgoing SMS or voice communication (user originated), and if hands-free function is active, or the hands-free is inactive but the user is not an active driver, communication is allowed without any restriction. Otherwise, if the user is an active driver, but the communication is not intended for emergency (for example E911), communication is disallowed and an audio and text messages are sent to the mobile terminal UI informing of restriction.

For an incoming SMS or voice communication (user terminated), and if hands-free function is active, or the hands-free is inactive but the user is not an active driver, communication is allowed without any restriction. Otherwise, if the user is an active driver, but the communication is not intended for emergency (for example: Reverse E911, Emergency Broadcast, etc.), communication is disallowed without any notification to the user (rings, etc. is suspended with “busy” signal indication and the incoming communication is redirected to the user mail-box.

In all of the mentioned embodiments, the monitoring application records the event of text and/or voice communication including time and location when the driver status was set to “non-active driver”, and depending on the user profile, such information is sent to the predefined recipients or stored for later evaluation.

### BRIEF DESCRIPTION OF THE DRAWINGS

A better understanding of the present invention can be obtained when the following detailed description of the preferred embodiment is considered in conjunction with the following drawings, in which:

FIG. 1 is an exemplary application of safe driving system;

FIG. 2 is an exemplary block diagram of a mobile terminal with safe driving system;

FIG. 3 is a flowchart of an exemplary method of driver verification process of the safe driving system;

FIG. 4 is a flowchart of an exemplary method of the supervisory process of the safe driving system.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

The following is a glossary of terms used in the present application:

Mobile Terminal—In the context of this invention any of various mobile communication devices, such as: smart-phones, feature-phones, cellular-phones, embedded wireless modems, etc. intended for communication over the wireless WAN (cellular, broadband, etc.) networks.

Accelerometer—In the context of this invention, device measuring acceleration in X/Y/Z planes sometime equipped with measurement of magnetic field (magnetometer, gyroscope), usually in form of Microelectromechanical System (MEMS).

Memory Medium—Any of various types of memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, etc.; or a non-volatile memory such as a magnetic media, e.g., a hard drive, or optical storage. The memory medium may comprise other types of memory as well, or combinations thereof. In addition, the memory medium may be located in a first processor in which the programs are executed, or may be located in a second different processor which connects to the first processor over a network, such as wireless PAN or WAN network or the Internet. In the latter instance, the second processor may provide program instructions to the first processor for execution. The term “memory medium” may include two or more memory mediums which may reside in different locations, e.g., in different processors that are connected over a network.

Application—the term “application” is intended to have the full breadth of its ordinary meaning. The term “application” includes: 1) a software program which may be stored in a memory and is executable by a processor; or 2) a hardware configuration program useable for configuring a programmable hardware element.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, Visual C, Java, assembly language, etc.; graphical programs (programs written in graphical programming languages); assembly language programs; programs that have been compiled to machine language; scripts; and other types of executable software. A software program may comprise two or more software programs that interoperate in some manner.

Computer System—any of various types of computing or processing systems, including cell phone, personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Text Message—in the context of this invention, any message (SMS, MMS, web browsing, etc.) requiring a textual interaction with the mobile terminal.

Voice Call—in the context of this invention, any voice communication between the mobile terminal and cellular network.

Driving Supervisor—in the context of this invention, any person or computer system authorized to receive remote alarms, notification or transmission of monitored user.

User—in the context of this invention, person supervised by the safe driving application.

Driver of the Vehicle—in the context of this invention, person actively involved in controlling of the moving vehicle, such as: car, track, bus, train, boat, etc.

### DESCRIPTION OF PREFERRED EMBODIMENT

The proposed method leverages on the accelerometer and or gyroscope functionality available in most mobile terminals. In the common implementation such accelerometer is used for various user interface (UI), such as: mobile terminal screen orientation; detection of “finger tapping”, gesture recognition, etc.

Acceleration (including translational movement) measures the change in velocity in a unit of time. It follows that acceleration is measured in meters per second squared (m/s²). Velocity, expressed in meters per second (m/s), includes both the rate of displacement and direction of movement. Furthermore, if we consider acceleration over various periods of time then vibration can be thought of as acceleration and deceleration that happens quickly and in a periodic manner, while shock is acceleration that occurs instantaneously but, unlike vibration, it is a non-periodic function that typically happens once.

As such by observing the acceleration in X/Y/Z planes (vectors), over the specific period of time, one skilled in art may easily obtain the object velocity and forces (such as shock due to an impact during an accident) applied to such object.

Information about the driver status may be obtained through the interaction with the user using mobile terminal UI or automatically, if the vehicle and the mobile terminals are equipped with near field communication (NFC), or RFID, etc. capabilities designed for such verification. Then, the knowledge of the driver status and the vehicle velocity use for controlling communication to/from the user. Furthermore, by detecting shock, an accident notification (including time and location), is integrated into a comprehensive safe drive system.

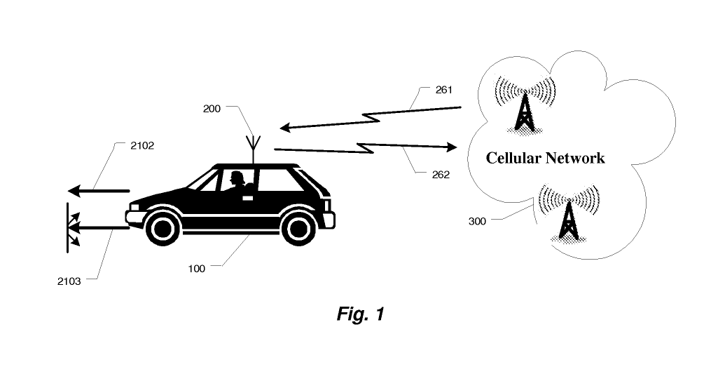

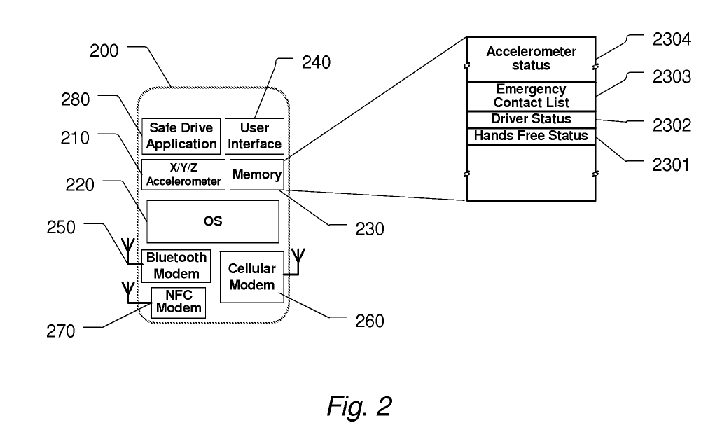

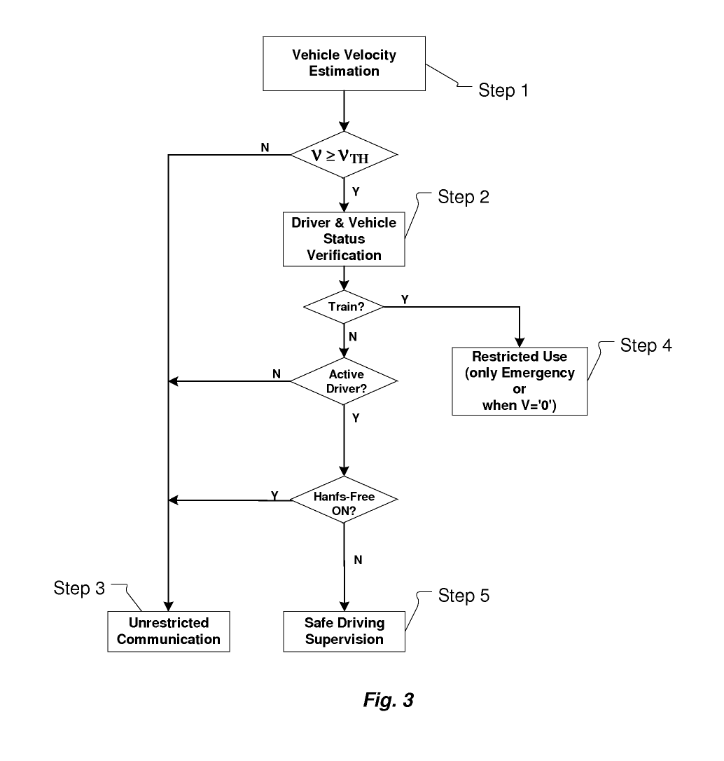

Such system may be implemented in the form of application residing in the user mobile terminal connected to the wireless WAN, such as cdma2000, WCDMA, LTE, WiMax, etc., and consequently to the Internet. An example of such system is presented in FIG. 1, FIG. 2 and FIG. 3.

The system of FIG. 1 and FIG. 2 consists of a vehicle 100, wireless mobile terminal 200 which residing within the vehicle and communicating with the wireless WAM network over the downlink RF channel 261 and uplink RF channel 262.

The mobile terminal 200 may include any type of device which may be used in a cellular network, e.g., RF communication, such as: cell-phones (including smart phones), personal digital assistants (PDAs) with mobile communication capabilities, wireless modem integrated into vehicle, laptops or computer systems with mobile communication components, and/or any device which is operable to communicate with a cellular network. The mobile terminal may use various different communication protocols, e.g., cdma2000 (1xRTT and EV-DO), UMTS, LTE, WiMax, or others).

Furthermore, the wireless terminal 200 consists of accelerometer function 210 which is controlled by the mobile terminal operating system (OS) 220, a memory subsystem 230, a user interface (UI) 240, a personal area network (PAN) modem function 250, such as Bluetooth, etc. to provide communication with the hands-free equipment, a wireless modem function providing communication to/from wireless WAN network 260, and NFC modem 270 to provide near field communication for driver verification function, and a safe driving application 280

The application 280 through mobile terminal OS 220 monitors the status of the hands-free function and periodically requests measure of acceleration along X, Y, and Z axes of motion from the mobile terminal accelerometer 210. From the X/Y/Z vectors, application calculates mobile terminal velocity 2102 and a shock 2103 values and store those values in their respective memory area.

The first information 2301 contains the hands-free status and is stored in the mobile terminal memory 230 and is valid from the time of first association of such functionality until the communication link with such functionality is terminated.

The second information 2302 contains the driver status and is stored in the mobile terminal memory 230 and valid until the velocity of the vehicle is “0” mph and the driver_valid_timer T_{DV} expires.

The third information 2303 contains user parameters, such as: emergency and insurance contact lists, T_{DV} timer value, etc. and is stored in the mobile terminal memory 230.

When the velocity status of the vehicle 2304 exceeds the predefined threshold, application enters Step 1 of the driver status verification process described in FIG. 3.

In Step 1, the vehicle velocity vector,

$$v = {lim}_{Δ t - 0} \frac{x ( t + Δ t ) - x ( t )}{Δ t} = \frac{d x}{d t} .$$

is obtained from the mobile terminal MEMS accelerometer and the velocity v of the vehicle which starts with velocity u and then accelerates at rate a for a period of time Δt is obtained as:

v=u+aΔt.

and the average velocity from:

$$\frac{( u + v )}{2}$$

which can be further filtered using IIR of FIR filtering function.

When the vehicle velocity exceeds a predefined threshold ν≧ν_{TH}, for example 5 mph, the verification process enters Step 2.

In Step 2, the driver verification process communicates with the user over the mobile terminal UI, and request conformation if: a) the user of the terminal is actively involved in the driving of this vehicle; b) the vehicle is a train.

It has to be emphasized that the verification of the driver status may be obtained through the interaction with the user using mobile terminal UI or automatically, if the vehicle and the mobile terminals are equipped with near field communication (NFC) capabilities designed for such verification.

If the answers to item a and item b are yes (user is a driver of a train), the application enters Step 5 in which only an emergency communication, such as E911, pre-approved emergency contacts, etc. are allowed. Otherwise, the train velocity must be at “0‘ mph for a duration of T_{DA} time, before unrestricted communication is allowed. Such unrestricted communication is suspended again when the velocity exceeds threshold ν≧ν_{TH}.

If the answer to item a and item b are yes are no (user is a vehicle but the vehicle is not a train), the application enters Step 3.

In Step 2, application verifies if the vehicle actively operated by the user is equipped with hands-free functionality. If the hands-free (HF) functionality is on (mobile terminal was associated with vehicle hands-free device), the unrestricted communication is allowed, HF_status variable stored.

If the hands-free (HF) functionality is off (mobile terminal has no communication with the vehicle hands-free device), the application enters Step 4—in which only restricted and supervised communication is allowed.

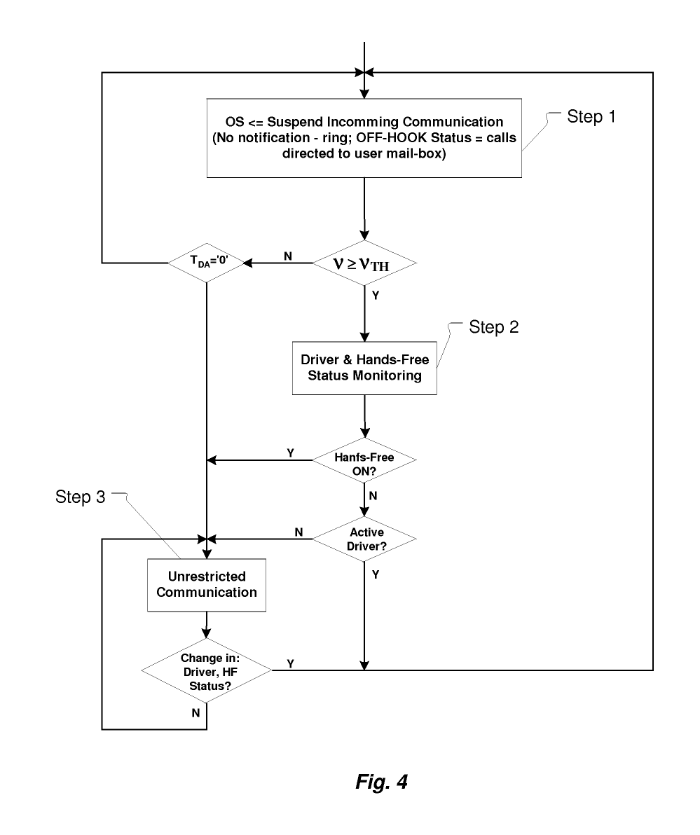

The safe driving supervision process is described below and in FIG. 4 and consists of several steps.

In Step 1, the application requests the mobile terminal OS to perform one or all of the following: a) disable incoming call notifications (ring, vibrate, etc.); b) set cellular phone function to OFF—similar as in the taking-off or landing airplane; c) set the cellular function to “busy”, does forcing all incoming communication to the user mail-box, then enter Step 2.

In Step 2, the supervising procedure, among the others, continuously monitors the hands-free status 2301, the driver status 2302, and the vehicle velocity status 2304.

If the hands-free status changes to on (the mobile terminal become associated with the hands-free function), or the driver status changed to no (driver become the passenger—verified through transition from driving-to-stop, or the mobile terminal was handed over to the passenger of the vehicle), or the vehicle velocity is “0” mph for a duration of T_{DA} time, the supervision process enters Step 3, does allowing unrestricted communication.

If the hands-free status if off (no hands-free function available), and driver status is yes (user is the active driver of the vehicle), and the vehicle velocity exceeds threshold ν≧ν_{TH}, and the user intends to make a call other than E911 or to any number other than one from approved emergency contact list, the supervision procedures enters Step 4, sends communication disallowed message to the user UI, then returns to Step 2, otherwise, if the user intends to make E911 or to any number other than one from approved emergency contact list, the supervision procedures enters Step 3 and allows unrestricted communication.

At any time during verification and supervision process if the instantaneous acceleration (shock to impact), exceeds a predefined threshold a≧±a_{TH}, does indicating an accident, the application records such occurrence, it's force, time and location, then depending on the user parameters sends such information over the wireless WAN network to the designated recipients, such as family members, insurance providers, E911 services, etc.

We claim:

1. A method for monitoring of compliance with safe driving rules through the suspension of all text messages and calls when the vehicle is in motion and the user of such communication as a driver unless such communication is intended for emergencies, the method comprising:
a cellular phone based monitoring application comprising of:
the means to determine the velocity of the vehicle;
the means to determine the type of the vehicle, whether it is an automobile or a train;
the means to determine the vehicle is equipped with a hands-free functionality.

2. The method of claim 1, wherein such monitoring application provides supervision of the safe driving behavior through:
verification of vehicle type and velocity;
verification of the vehicle active driver;
verification of the vehicle hands-free functionality.

3. The method of claim 1, wherein such safe driving monitoring application is capable of suspending all incoming and outgoing communication to the user of mobile terminal if:
the user of the communication device is a train driver and the train is in motion;
the user of the communication device is an active driver of an automobile (car, bus, etc.) and such vehicle is in motion and not equipped with hands-free functionality.

4. A method of claim 1, wherein such safe driving monitoring application is capable of reinstating unrestricted communication when:
the vehicle is no more in motion;
the status of the hands-free functionality changed;
the status of the active driver changed.

5. The method of claim 2, wherein the verification of the vehicle velocity is obtained through the observation of an output of the mobile terminal accelerometer.

6. The method of claim 2, wherein the verification of the vehicle velocity is obtained through the observation of Doppler frequency shift obtained by the mobile terminal.

7. The method of claim 2, wherein the verification of the vehicle velocity is obtained through the observation of Doppler frequency shift obtained by the cellular network infrastructure.

8. The method of claim 2, wherein the verification of the vehicle driver is obtained through the interaction with the user mobile terminal UI (user interface).

9. The method of claim 2, wherein the verification of the vehicle driver status is obtained through communication with NFC or other PAN (Personal Access Network) wireless functionality designed to support such function.

10. The method of claim 2, wherein the verification of the vehicle driver status is obtained through the interaction with the user mobile terminal UI (user interface).

11. The method of claim 2, wherein the verification of the vehicle driver status is obtained by the wireless network infrastructure through signaling.

12. The method of claim 1, wherein such application can detect a shock indicating an accident by observing the output of mobile terminal accelerometer.

13. The method of claim 12, wherein after such accident occurred, application collects vehicle speed, location, intensity of the shock, driver and hands-free status and either store such information in the mobile terminal memory or sends those to the predefined destinations.

14. A computer program executable on a mobile terminal, wherein the program is capable of supervising the safe driving habits and comprising:
a first set of instructions to obtain the vehicle velocity;
a second set of instructions to obtain the driver status;
a third set of instruction to obtain the vehicle hands-free status.

15. A computer program of claim 14, executable on a mobile terminal, wherein the program suspends all incoming and outgoing communication with such mobile terminal upon determination:
the vehicle is in motion and the user is the vehicle active driver and the vehicle has no active hands-free function enabled;
the vehicle is in motion and the user is the vehicle and the vehicle is a train.

16. A computer program of claim 14, executable on a mobile terminal, wherein the program reinstate unrestricted communication with such mobile terminal upon determination that the vehicle is no longer in motion, or the hands-free function is available or that the user is not actively driving the vehicle.

17. A computer program of claim 14, executable on a mobile terminal, wherein the program upon recording a shock due to an accident records such including: time, location, velocity, intensity, driver and hands-free status in the application memory.

18. A computer program of claim 14, executable on a mobile terminal, wherein the program upon recording a shock due to an accident records such including: time, location, velocity, intensity, driver and hands-free status and sends such information using the wireless WAN network to the predefined destination.
